(19) United States
(12) Patent Application Publication
(10) Pub. No.: US 2026/0208682 A1
(43) Pub. Date: Jul. 23, 2026

(54) METHOD FOR MANUFACTURING SOUND-ABSORBING AND HEAT-INSULATING COMPOSITE FABRIC, AND SOUND-ABSORBING AND HEAT-INSULATING COMPOSITE FABRIC MANUFACTURED THEREBY

(71) Applicant: AMOGREENTECH CO., LTD., Gimpo-si (KR)

(72) Inventors: Chan KIM, Gimpo-si (KR); Seoung-Hoon LEE, Gimpo-si (KR); Yun-Mi SO, Gimpo-si (KR)

(73) Assignee: AMOGREENTECH CO., LTD., Gimpo-si (KR)

(21) Appl. No.: 19/144,530

(22) PCT Filed: Dec. 19, 2023
(86) PCT No.: PCT/KR2023/020987

§ 371 Date: Jun. 30, 2025

(30) Foreign Application Priority Data
Dec. 29, 2022 (KR) 10-2022-0189728

(51) Int. Cl. B60R 13/08; B32B 5/02; B32B 5/16; B32B 7/12; D04H 1/4318; D04H 1/44; D04H 1/728

(52) U.S. Cl. CPC B60R 13/0884; B32B 5/02; B32B 5/16; B32B 7/12; B60R 13/0876; B32B 2250/02; B32B 2250/20; B32B 2262/0238; B32B 2307/102; B32B 2307/304; B32B 2307/737; D04H 1/4318; D04H 1/44; D04H 1/728; D10B 2505/12

(57) ABSTRACT

A method for manufacturing a sound-absorbing and heat-insulating composite fabric is provided. Accordingly, the composite fabric can maximize heat insulation and sound absorption performance, so that it can be utilized as an ultra-thin and ultra-lightweight sound-absorbing and heat-insulating material compared to conventional sound-absorbing materials. Therefore, it can be applied not only to transportation means including automobiles, ships, trains, and airplanes, but also to construction structures such as buildings and factories, and the like to simultaneously exhibit sound absorption and heat insulation.

### CROSS REFERENCE TO THE RELATED APPLICATIONS

This application is the national phase entry of International Application No. PCT/KR2023/020987, filed on Dec. 19, 2023, which is based upon and claims priority to Korean Patent Application No. 10-2022-0189728, filed on Dec. 29, 2022, the entire contents of which are incorporated herein by reference

### TECHNICAL FIELD

The present invention relates to a method for manufacturing a sound-absorbing and heat-insulating composite fabric and a sound-absorbing and heat-insulating composite fabric manufactured thereby.

### BACKGROUND

Industrially, nanofibers are defined as fibrous materials having a diameter of less than 1 μm, which is the limit diameter of existing melt spinning, solution spinning, or the like. General nanofibers can be manufactured by methods such as electrospinning, self-assembly, drawing, and chemical vapor deposition (CVD), but the electrospinning is known to be the most effective method in terms of application and mass production of nanofibers. The electrospinning is a method for forming a porous web-shaped membrane in which, as a polymer solution flies toward a current collector by an electric field formed by applying an electric field to the polymer solution or melt, the solvent is volatilized, and nanofibers having a diameter of less than 1 μm are stacked on the current collector in a three-dimensional network shape. These nanofibers have an open pore structure with pores connected from the surface to the back, a high porosity of 60 to 80%, and a high specific surface area compared to the volume, so they have the advantage of being applicable as basic materials in almost all industrial fields, such as moisture-permeable and waterproof fabrics, air and water purification filters, electrical and electronic materials, and biomedical materials.

Meanwhile, aerogel is the lightest air-like solid on Earth, and is an ultra-low-density advanced material with a porosity of 90 to 99.8%, a specific surface area of less than 2,000 m²/g, and a thermal conductivity of 0.005 to 0.1 W/mk. Aerogel with such nanoporous structure is a very efficient super-insulating material due to its low thermal conductivity and high light transmittance, and is being applied to insulation materials for electronic equipment in spacecraft, sportswear, paints, construction materials, cosmetics, and medicine.

Recently, as the mobility paradigm has changed from internal combustion engines to electric motors, automobile parts has decreased by 30% or more, and the design of existing parts is changing so that they can be applied to narrow spaces due to the expansion of the vehicle interior space. Since electric vehicles do not have engine noise, road noise from various places in the front, incoming wind noise, and high-frequency noise (high noise sensitivity) from the electric motor are relatively big issues. In particular, electric vehicles have a wider interior space than internal combustion engines, so the noise is amplified due to resonance, and thus there is a high demand for sound absorption. In addition, since the vehicle driving and internal temperature control system are operated simultaneously using battery power, the operation of the internal temperature control system affects the driving distance, and thus, the insulation interior material for internal temperature management takes on an important position.

In addition, porous materials such as PET nonwoven fabric, ultra-fine fiber, urethane foam, and nanofiber, which weigh about 20 kg per vehicle, are used as sound-absorbing materials for noise reduction in electric vehicles, and thick insulation is applied separately for insulation.

However, various sound-absorbing and heat-insulating materials developed to date are insufficient to demonstrate the high level of sound-absorbing and heat-insulating performance required for electric vehicles, or even if they have such sound-absorbing and heat-insulating performance, the weight and volume of the heat-insulating and sound-absorbing materials increase, which reduces the interior space of the vehicle due to the heat-insulating and sound-absorbing materials, and the increased weight increases the loss of electric energy when driving the vehicle, which shortens the driving distance.

Therefore, there is an urgent need to develop a heat-insulating and sound-absorbing material that can satisfy the quietness and insulation of the vehicle, and also be lightweight and thin to secure sufficient interior space of the vehicle and minimize the loss of electric energy due to the weight of the heat-insulating and sound-absorbing materials.

### SUMMARY

### Technical Problem

The present invention has been devised in consideration of the above points, and aims to provide a method for manufacturing a lightweight and thin sound-absorbing and heat-insulating composite fabric having both sound-absorbing and heat-insulating properties, and a sound-absorbing and heat-insulating composite fabric implemented through the same.

In addition, the present invention has another purpose of providing an automobile interior and exterior material including a sound-absorbing and heat-insulating composite fabric so that the sound-absorbing and heat-insulating performance can be maximized by controlling the position and arrangement of the layers constituting the sound-absorbing and heat-insulating composite fabric, and an electric vehicle equipped with the same.

Meanwhile, it is revealed that the present invention was made with the support of the following national research and development project.

[Task Identification Number] 1716700171 [Task Number] P0017167

[Ministry Name] Ministry of Trade, Industry and Energy [Task Management (Specialized) Organization] Korea Institute for Advancement of Technology

[Research Project Name] World Class Plus Project

[Research Task Name] Development of manufacturing technology for high-performance waterproof, dustproof, and sound-permeable fabrics for protecting electronic device with a nanofiber-based IP 68 rating or higher and an acoustic loss rate of 1 dB or less

[Contribution Rate] 1/1 [Task Executing Organization] Amogreentech Co., Ltd.

[Research Period] Apr. 1, 2021~Dec. 31, 2024

### Technical Solution

In order to solve the above-described problem, the present invention provides a method for manufacturing a sound-absorbing and heat-insulating composite fabric, the method including the steps of: (1) preparing a first fiber web comprising first fibers, which include aerogel particles and have a diameter of 1 μm or less, and a second fiber web comprising second fibers, which have a diameter larger than that of the first fibers; and (2) laminating the first fiber web and the second fiber web by applying heat and pressure.

According to one embodiment of the present invention, the aerogel particles may be included in a content of 3 to 50% by weight in the first fiber.

In addition, the diameter of the aerogel particle and the diameter of the first fiber may have a diameter ratio of 1:3.5 to 50.

In addition, the second fiber in the second fiber web may have an average diameter of 5 to 30 μm, and the thickness of the second fiber web may be 3 to 40 mm.

In addition, the step (2) may be performed after disposing a third fiber web including a thermally adhesive resin between the first fiber web and the second fiber web.

In addition, the first fiber may have a side-by-side cross-section in which a thermal adhesion portion formed of the thermally adhesive resin and a fiber portion formed of a polymer resin having a higher melting point than the thermally adhesive resin are adjacently disposed in a cross-section perpendicular to the longitudinal direction of the fiber, and the aerogel particles may be included in the fiber portion.

In addition, the third fiber web may include a third fiber having a diameter of 1.5 μm or less but having a diameter equal to or greater than the diameter of the first fiber, and the third fiber may be a thermally adhesive composite fiber having a side-by-side cross-section in which a thermal adhesion portion formed of the thermally adhesive resin and a fiber portion formed of a polymer resin having a higher melting point than the thermally adhesive resin are adjacently disposed in a cross-section perpendicular to the longitudinal direction of the fiber.

In addition, the thermally adhesive resin may have a melting point that is at least 50° C. lower than the melting points of the first fiber and the second fiber.

In addition, the fiber portion may further include aerogel particles in a content of 3% by weight or more based on the weight of the fiber portion.

In addition, the area of the thermal adhesion portion in the cross-section of the third fiber may be 50% or less of the cross-section area.

In addition, the area of the thermal adhesion portion may be 10 to 30% of the cross-section area.

In addition, the present invention provides a sound-absorbing and heat-insulating composite fabric, comprising: a first fiber web comprising first fibers, which include aerogel particles and have a diameter of 1 μm or less, a second fiber web comprising second fibers, which have a diameter larger than that of the first fibers, and a fusion portion positioned at an interface between the first fiber web and the second fiber web to bond the first fiber web and the second fiber web.

According to one embodiment of the present invention, the aerogel particles may be included in a content of 3 to 30% by weight in the first fiber.

In addition, the diameter of the aerogel particle and the diameter of the first fiber may have a diameter ratio of 1:10 to 50.

In addition, a third fiber web comprising third fibers is disposed between the first fiber web and the second fiber web, wherein the third fibers are side-by-side type thermally adhesive composite fibers in which a fiber portion and a thermal adhesion portion having a melting point, for example, at least 50° C. lower than the fiber portion are disposed adjacently within a cross section and which have a diameter of 1.5 μm or less, and the fusion portion may be formed by fusion between each of the first fiber and the second fiber located at the interface and the thermal adhesion portion in the third fiber.

In addition, the fiber portion may further include aerogel particles in a content of 3 to 30% by weight based on the weight of the fiber portion.

In addition, the first fiber may have a side-by-side cross-section in which a thermal adhesion portion formed of the thermally adhesive resin and a fiber portion formed of a polymer resin having a higher melting point than the thermally adhesive resin are adjacently disposed in a cross-section perpendicular to the longitudinal direction of the fiber, the aerogel particles may be included in the fiber portion, and the fusion portion may be formed by fusion between the thermal adhesion portion and the second fiber.

In addition, the present invention provides an interior and exterior material for an automobile, including a sound-absorbing and heat-insulating composite fabric according to the present invention.

According to one embodiment of the present invention, the sound-absorbing and heat-insulating composite fabric may be included so that light including infrared rays and sound waves including audible frequencies are incident on the first fiber web of the sound-absorbing and heat-insulating composite fabric.

### Advantageous Effects

The method for manufacturing a sound-absorbing and heat-insulating composite fabric according to the present invention is suitable for implementing a sound-absorbing and heat-insulating composite fabric which has both sound-absorbing and heat-insulating properties and is lightweight and thin. In addition, the implemented sound-absorbing and heat-insulating composite fabric can maximize heat insulation and sound absorption performance, so that it can be utilized as an ultra-thin and ultra-lightweight sound-absorbing and heat-insulating material compared to conventional sound-absorbing materials. Therefore, it can be applied not only to transportation means including automobiles, ships, trains, and airplanes, but also to construction structures such as buildings and factories, and the like to simultaneously exhibit sound absorption and heat insulation.

### BRIEF DESCRIPTION OF DRAWINGS

FIG. 1 is a schematic diagram of a manufacturing process of a sound-absorbing and heat-insulating composite fabric according to one embodiment of the present invention,

FIG. 2 is a cross-sectional view and a partially enlarged view of a sound-absorbing and heat-insulating composite fabric according to one embodiment of the present invention,

FIG. 3 is a cross-sectional view along line X-X′ of FIG. 2,

FIG. 4 is a cross-sectional view and a partially enlarged view of a sound-absorbing and heat-insulating composite fabric according to one embodiment of the present invention,

FIGS. 5A to 5C are cross-sectional views along line Y-Y′ of FIG. 4,

FIGS. 6A and 6B are schematic diagrams of an interface where thermal adhesion is performed between a first fiber web and a second fiber web, wherein FIG. 6A is a schematic diagram showing thermal adhesion at the interface between the first fiber web and the second fiber web according to one embodiment of the present invention, and FIG. 6B is a schematic diagram showing thermal adhesion performed by interposing a hot melt agent at the interface between the first fiber web and the second fiber web,

FIG. 7 is a cross-sectional view and a partially enlarged view of a sound-absorbing and heat-insulating composite fabric according to one embodiment of the present invention,

FIG. 8 is a cross-sectional view along line Z-Z′ of FIG. 7,

FIG. 9 is a scanning electron microscope (SEM) photograph of a first fiber web included in a sound-absorbing and heat-insulating composite fabric according to one embodiment of the present invention,

FIG. 10 is a scanning electron microscope (SEM) photograph of a cross-section of a sound-absorbing and heat-insulating composite fabric according to one embodiment of the present invention,

FIG. 11 is a scanning electron microscope (SEM) photograph of a first fiber web included in a sound-absorbing and heat-insulating composite fabric according to one embodiment of the present invention,

FIG. 12 is a graph of a reflectance measurement for light in the visible and near-infrared wavelength ranges performed on a sound-absorbing and heat-insulating composite fabric according to Example 1,

FIG. 13 is a schematic diagram of an evaluation method when evaluating the insulation performance of Experimental Example 2, and

FIG. 14 is a graph evaluating the sound-absorbing performance for various examples and comparative examples of the present invention.

### DETAILED DESCRIPTION OF THE EMBODIMENTS

Hereinafter, with reference to the accompanying drawings, embodiments of the present invention will be described in detail so as to be easily implemented by one of ordinary skill in the art to which the present invention pertains. The present invention may be embodied in a variety of forms and is not limited to the embodiments described herein. In order to clearly describe the present invention in the drawing, parts irrelevant to the description are omitted from the drawings; and throughout the specification, same or similar components are referred to as like reference numerals.

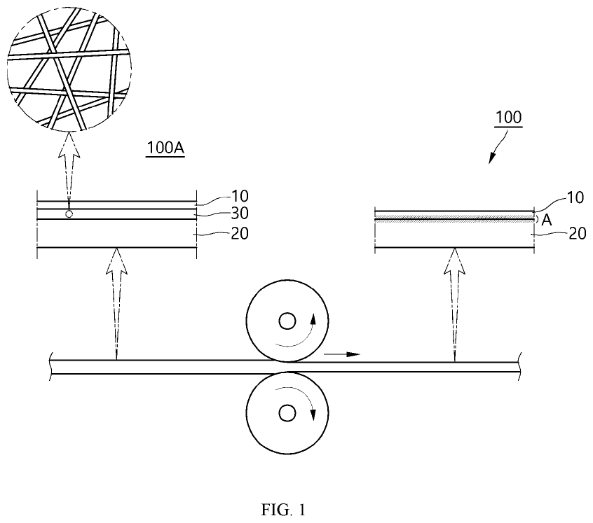

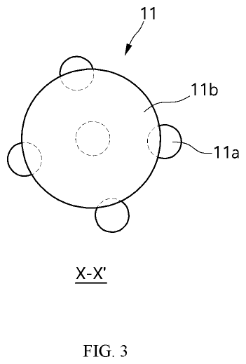

Referring to FIGS. 1 to 3, a sound-absorbing and heat-insulating composite fabric 100 according to one embodiment of the present invention may be manufactured through the steps of: (1) preparing a first fiber web 10 comprising first fibers 11, which include aerogel particles 11a and have a diameter of 1 μm or less, and a second fiber web 20 comprising second fibers 21, which have a diameter larger than that of the first fibers 11; and (2) arranging a third fiber web 30 comprising a thermally adhesive resin between the first fiber web 10 and the second fiber web 20 and then applying heat and pressure to laminate the first fiber web and the second fiber web.

First, as step (1) of the present invention, a step of preparing a first fiber web 10 comprising first fibers 11, which include aerogel particles 11a and have a diameter of 1 μm or less, and a second fiber web 20 comprising second fibers 21, which have a diameter larger than that of the first fibers 11 is performed.

The first fiber web 10 is a main functional layer that exhibits sound-absorbing and heat-insulating performance in the sound-absorbing and heat-insulating composite fabric, and is manufactured to include first fibers 11 having a diameter of 1 μm or less. The first fiber web 10 may be manufactured by a known method capable of manufacturing fibers having a diameter of 1 μm or less. For example, the first fiber web 10 may be manufactured by electrospinning. The electrospinning may be performed specifically using known electrospinning methods and devices such as pure electrospinning, melt-blown electrospinning, bubble electrospinning, centrifugal electrospinning, and nozzleless electrospinning, and the present invention does not particularly limit the specific spinning conditions and methods therefor.

Specifically, the first fiber web 10 may be manufactured through the first fiber 11 obtained by electrospinning a spinning solution in which a known polymer capable of electrospinning is dissolved or melted. For example, the first fiber 11 may be a polyethylene glycol derivative including polyethylene glycol dialkyl ether and polyethylene glycol dialkyl ester, a polyoxide including poly(oxymethylene-oligo-oxyethylene), polyethylene oxide and polypropylene oxide, polyvinylacetate, poly(vinylpyrrolidone-vinylacetate), polystyrene and polystyrene acrylonitrile copolymer, polyacrylonitrile (PAN), a polyacrylonitrile copolymer including polyacrylonitrile methyl methacrylate copolymer, polymethyl methacrylate, polyurethane, polyvinyl alcohol, polylactic acid, polyacrylic acid, or a fluorine-based compound. In addition, the fluorine-based compound may include a fiber portion 11b formed of a fiber-forming component, which is at least one compound selected from the group consisting of polytetrafluoroethylene (PTFE)-based compounds, tetrafluoroethylene-perfluoroalkyl vinyl ether copolymer (PFA)-based compounds, tetrafluoroethylene-hexafluoropropylene copolymer (FEP)-based compounds, tetrafluoroethylene-hexafluoropropylene-perfluoroalkyl vinyl ether copolymer (EPE)-based compounds, tetrafluoroethylene-ethylene copolymer (ETFE)-based compounds, polychlorotrifluoroethylene (PCTFE)-based compounds, chlorotrifluoroethylene-ethylene copolymer (ECTFE)-based compounds, and polyvinylidene fluoride (PVDF)-based compounds.

In addition, the spinning solution may further include a solvent suitable for dissolving the fiber-forming component constituting the above-described fiber portion 11b, wherein the solvent may be a known solvent used in a spinning solution for electrospinning, and as a non-limiting example thereof, the solvent may be at least one selected from the group consisting of dimethyl acetamide (DMA), N,N-dimethylformamide (DMF), N-methyl-2-pyrrolidinone (NMP), dimethyl sulfoxide (DMSO), tetra-hydrofuran (THF), di-methylacetamide (DMAc), ethylene carbonate (EC), diethyl carbonate (DEC), dimethyl carbonate (DMC), ethyl methyl carbonate (EMC), propylene carbonate (PC), water, acetic acid, and acetone.

Meanwhile, aerogel particles 11a may be included in the spinning solution, and thereby, the aerogel particles 11a can be stably fixed on the first fiber 11. That is, the method of providing aerogel particles on the fibers includes a method of spinning aerogel particles together with a fiber-forming component, or a method of fixing aerogel particles through coating on the surface of already manufactured fibers. However, the latter method requires a separate attachment means such as a binder for fixing the aerogel particles, and even when the binder is used, it may be difficult to uniformly disperse and fix the aerogel particles on the surface of the fibers constituting the fiber web. In addition, when the coating solution is applied, the pores of the fiber web may be blocked, and in this case, the porosity and pore diameter of the fiber web may be reduced, which may result in a decrease in sound absorption and heat insulation performance. In addition, when the pores of the fiber web surface are blocked and flattened due to the coating, a sufficient scattering effect may not be achieved through the aerogel particles. That is, light incident on the surface of a fiber web formed of fibers having a diameter of 1 μm can have a surface morphology enough to cause light scattering even by the fiber web itself through the thin diameter of the fibers forming the fiber web, the curved fiber surface, and the fine gap between the fibers. However, when the surface of the fiber web is flattened due to coating, it may be difficult for the fiber web to achieve the increased scattering effect due to the surface morphology and aerogel even if the aerogel particles are provided on the flattened surface.

In this respect, by mixing the aerogel particles in the spinning solution for manufacturing the fiber and spinning them together, it may be advantageous to implement the first fiber 11 in which the porosity and pore diameter of the implemented first fiber web 10 are maintained intact, while the aerogel particles are uniformly dispersed on the first fiber 11 and at least a portion of the aerogel particles are exposed to the outside on the surface of the first fiber 11.

In addition, as the aerogel particle 11a, any known aerogel particle may be used without limitation. The aerogel particle 11a is a solid material having micropores and mesopores and composed of a highly porous network, wherein the high porosity and specific surface area of the particle itself are advantageous for exhibiting an insulation effect, and the rough surface imparted to the smooth first fiber surface can help increase light scattering. The aerogel particles may be any known aerogel particle without limitation, and as non-limiting examples thereof, organic aerogels such as polyimide aerogel, and inorganic aerogels such as metal carbide aerogel, carbon aerogel, silica aerogel, and alumina aerogel may be used alone or in combination of two or more thereof.

In addition, the particle diameter of the aerogel particles 11a may be determined in consideration of the diameter of the first fiber 11 to be implemented, and preferably, the particle diameter of the aerogel particles and the diameter of the first fiber may have a diameter ratio of 1:3 to 100, more preferably 1:3.5 to 50, even more preferably 1:10 to 50, and even more preferably 1:10 to 35, whereby the contained aerogel particles 11a are distributed on the first fiber 11 so that they are exposed on the surface of the first fiber 11, and have excellent spinning property, which is advantageous for mass production. When the diameter of the first fiber is less than three times that of the aerogel particle, there is a concern that excessive yarn breakage may occur during spinning, and even if yarn breakage does not occur, the mechanical strength of the first fiber web may be significantly reduced, and the amount of aerogel particles that fall off during the post-process using the first fiber web or during the use of the implemented sound-absorbing and heat-insulating composite fabric may increase, causing a change in physical properties that reduces sound absorption and heat insulation performance. In addition, when the diameter of the first fiber exceeds 100 times that of the aerogel particle, even if the content of the aerogel particles is increased, the content of the aerogels exposed to the surface of the first fiber is small and most of them are distributed inside the first fiber, so the expression of the heat insulation and sound absorption performance through the aerogel may be minimal.

Meanwhile, the aerogel particles 11a may have a particle diameter of, for example, 20 to 300 nm, more preferably 20 to 100 nm. When the particle diameter of the aerogel particles is less than 20 nm, it may be difficult to uniformly disperse the aerogel particles in the spinning solution, and it may be difficult to express sufficient heat insulation and sound absorption performance because they may be distributed inside the fiber rather than exposed to the fiber surface. In addition, when the particle diameter of the aerogel particles exceeds 300 nm, the first fiber 11 being spun may be broken, resulting in poor spinning properties, and there is a concern that the spinning nozzle may be clogged due to the aggregation of the aerogel particles.

In addition, the aerogel particles 11a may be included in an amount of 3 to 50 parts by weight, more preferably 3 to 30 parts by weight, and even more preferably 5 to 30 parts by weight, based on 100 parts by weight of the fiber-forming component contained in the spinning solution. When the aerogel particles are contained in an amount of less than 3 parts by weight based on the fiber-forming component in the spinning solution, it may be minimal to achieve the sound absorption and heat insulation effects through the aerogel. When more than 50 parts by weight are included, the spinning workability, such as clogging of the spinning nozzle, may deteriorate, and the spinning properties, such as yarn breakage, may be poor, or the mechanical strength of the implemented first fiber web may be low, resulting in poor durability. In addition, since the aerogel particles may easily fall off in the first fiber web state, it may be difficult for the sound absorption and heat insulation performance to be stably expressed for a long period of time.

The first fiber 11 electrospun through the above-described spinning solution may have a diameter of 1 μm or less, preferably 200 to 500 nm, and thus is advantageous in achieving sound absorption and heat insulation performance while securing the spinning properties even when containing the aerogel. Here, the diameter of the first fiber 11 refers to a diameter based on the circumference of the fiber portion 11b excluding the protruding aerogel particles without considering the size of the aerogel particles protruding outward from the fiber cross-section.

In addition, the first fiber web 10 formed through the spun first fiber 11 may have a thickness of 5 to 100 μm, more preferably 5 to 50 μm, and a basis weight of, for example, 10 to 200 g/m², more preferably 10 to 100 g/m², and thereby can be more advantageous in achieving the purpose of the present invention.

Meanwhile, the first fiber web 10 may be implemented by subjecting an aggregate of the first fibers 11 accumulated on a predetermined collector to a calendering process. Alternatively, it is to be noted that the first fiber web 10 may be implemented by being directly electrospun on the third fiber web 30 to be described later.

Next, the second fiber web 20 functions as a support function for the first fiber web 10 and as a member for sound absorption and heat insulation in itself. As the second fiber web 20, any nonwoven fabric known in the art as a sound-absorbing or heat-insulating material may be used without limitation, and examples thereof may include a melt-blown nonwoven fabric, a spun-bonded nonwoven fabric, or an air-laid nonwoven fabric, but are not limited thereto.

In addition, the second fibers 21 constituting the second fiber web 20 may have an average diameter of 5 to 30 μm, more preferably 10 to 25 μm. In addition, the thickness of the second fiber web 20 may be 3 to 40 mm, more preferably 3 to 20 mm, and the basis weight may be 35 to 80 g/m², which may be advantageous in expressing the desired sound absorption and heat insulation performance.

In addition, the second fiber web 20 may have, for example, an average pore diameter of 20 to 100 μm and a porosity of 50 to 90%, but is not limited thereto.

Next, as step (2) according to the present invention, a step of applying heat and pressure to laminate the first fiber web 10 and the second fiber web 20 is performed.

For example, in step (2), a thermally adhesive resin is provided between the first fiber web 10 and the second fiber web 20, and the thermally adhesive resin is melted and solidified to form a fusion portion (A), thereby laminating the first fiber web 10 and the second fiber web 20.

As an example, as shown in FIG. 1, the thermally adhesive resin may be included in a third fiber web 30, and the third fiber web 30 may be disposed between the first fiber web 10 and the second fiber web 20, and then heat and pressure may be applied.

The third fiber web 30 includes the thermally adhesive resin as an adhesive member for integrating the first fiber web 10 and the second fiber web 20 by melting the thermally adhesive resin, and any adhesive member commonly referred to as a hot melt web may be used without limitation. In the third fiber web, for example, the third fiber may be composed of fibers made of only a thermally adhesive resin, or composed of fibers made of only a thermally adhesive resin and different fibers that perform a support function, or composed of composite fibers that include a non-thermally adhesive resin portion that performs a support function within the fiber and a thermally adhesive resin portion that is at least partially exposed to the surface.

In addition, the thermally adhesive resin contained in the third fiber forming the third fiber web 30 may have a melting point that is, for example, at least 50° C. lower than the melting points of the first fiber 11 and the second fiber 21 so as to prevent damage from occurring due to melting of the first fiber web 10 and the second fiber web 20 by heat or ultrasonic waves applied. In addition, as the thermally adhesive resin, any known resin commonly referred to as a low-melting-point resin may be used without limitation, and non-limiting examples thereof may include at least one selected from the group consisting of ethylene-vinylacetate copolymers, polyesters, polyamides, polyolefins, and rubber-based resins.

In addition, there may be a large difference in diameter between the first fiber 11 constituting the first fiber web 10 and the second fiber 21 constituting the second fiber web 20 described above, and in this case, it may be difficult to obtain high bonding strength because the contact area between the fibers at the interface between the first fiber web and the second fiber web is not large. Accordingly, the third fiber constituting the third fiber web 30 is preferably configured to have a diameter larger than that of the first fiber 11 and smaller than that of the second fiber 21, which may be advantageous in further increasing the bonding strength at the interface between the first fiber web 10 and the third fiber web 30 and the interface between the second fiber web 20 and the third fiber web 30.

In addition, the thermally adhesive resin melted from the third fiber web 30 may be introduced through the surface pores of the first fiber web 10 and the second fiber web by the pressure applied in step (2), so that a fusion portion (A) may be formed in which the thermally adhesive resin penetrates and solidifies from the surface of the first fiber web 10 and the second fiber web 20 to a predetermined thickness.

In this case, the heat applied may be at least 5° C. higher than the melting point of the thermally adhesive resin, but is not limited thereto, and may be changed in consideration of the degree of pressure applied, the thickness of the third fiber web, etc.

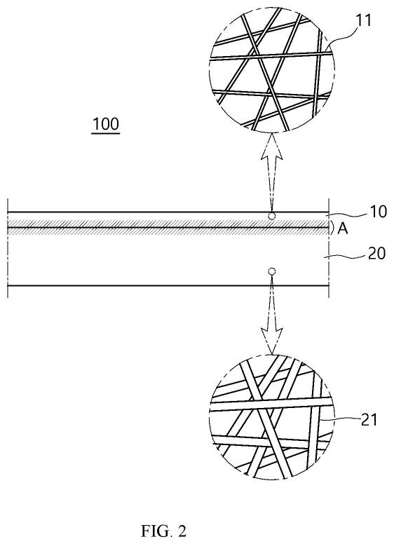

In addition, although FIGS. 1 and 2 illustrate that the third fiber web 30 is completely melted by the heat and pressure applied to a calendar roll, it is to be noted that unlike FIGS. 1 and 2, there may be a fiber web portion in which the third fiber web 30 is not melted to a predetermined thickness between the first fiber web 10 and the second fiber web 20 after the heat and pressure are applied.

Alternatively, unlike that shown in FIG. 1, the thermally adhesive resin may be contained as fibers constituting the second fiber web 20, or as a component within the fibers, thereby forming a fusion portion at the interface between the first fiber web 10 and the second fiber web 20 to form a laminate.

Meanwhile, the fusion portion (A) may penetrate to a predetermined depth from the surface of each fiber web and solidify without blocking the pores located at the adjacent interface between the first fiber web 10 and the second fiber web 20. However, since the pores of the first fiber web 10 are very small compared to the second fiber web 20, the fusion portion that flows into the first fiber web 10 and is solidified may block most of the pores in a portion of the first fiber web 10 corresponding to that portion, and in this case, the heat insulation or sound absorption performance may be deteriorated.

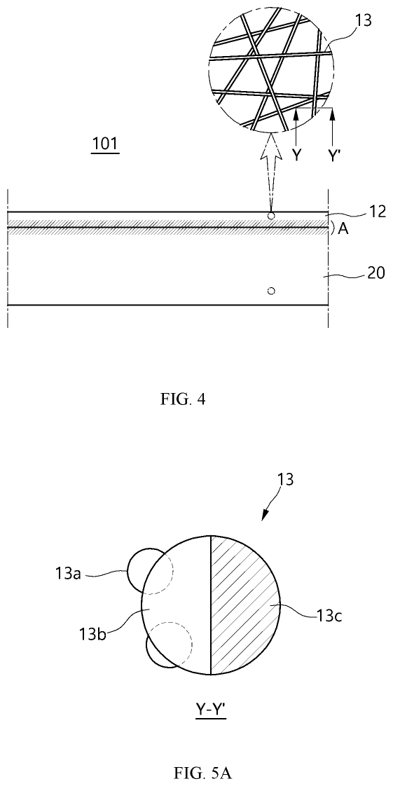

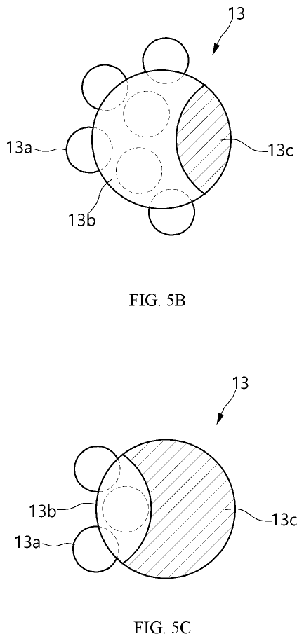

Accordingly, in the sound-absorbing and heat-insulating composite fabric 101 according to one embodiment of the present invention, a first fiber web 12 provided as shown in FIGS. 4 and 5A to 5C may be formed of a first fiber 13 having a side-by-side cross-section in which a thermal adhesion portion 13c formed of the thermally adhesive resin and a fiber portion 13b formed of a polymer resin having a melting point higher than that of the thermally adhesive resin are adjacently disposed in a cross-section perpendicular to the longitudinal direction of the fiber.

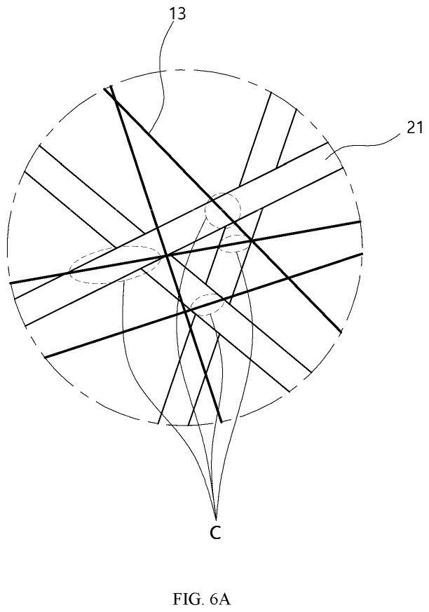

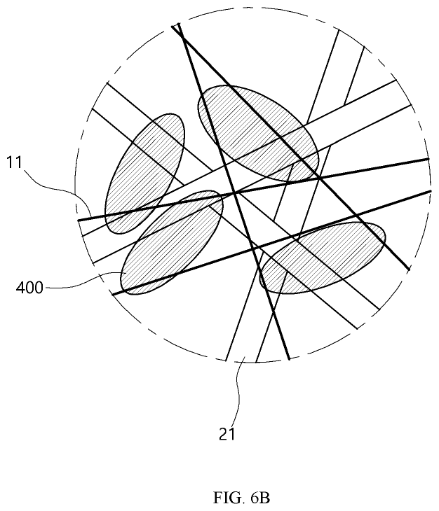

The first fiber web 12 composed of the first fiber 13 having a side-by-side cross-section by the thermal adhesion portion 13c and the fiber portion 13b can be fused (C) at the interface formed between the first fiber 13 and the second fiber 21 in the second fiber web 20 to be laminated as shown in FIG. 6A, so that there is an advantage in that thermal adhesion can be performed without affecting the pores of each of the first fiber web 12 and the second fiber web 20. However, as shown in FIG. 6B, when a different type of hot melt member 400 is contained, the pores of both the first fiber web 10 formed of the first fiber 11 and the second fiber web 20 formed of the second fiber 21 may be varied.

Preferably, the area of the thermal adhesion portion 13c in the cross-section of the first fiber 13 may be 50% or less of the cross-section area, and when the area of the thermal adhesion portion 13c exceeds 50%, the pores may be clogged during the thermal adhesion process with the second fiber web 20, and in this case, there is a concern that the properties such as heat insulation and sound absorption may deteriorate and that a uniform pore structure distribution may not be achieved. More preferably, the area of the thermal adhesion portion 13c may be 10 to 30% of the cross-section area, and thereby, the adhesion performance can be significantly improved through the linear contact with the second fiber 21 of the second fiber web 20. However, when the thermal adhesion portion 13c is included in an amount of less than 10%, there is a concern that the thermal adhesion performance may be significantly reduced, which is not preferable.

In addition, the thermal adhesion portion 13c can be electrospun and can use a thermally adhesive resin having a low melting point, and for example, may include at least one of low melting point (low polymer) polyurethane, polystyrene (PS), polyvinyl alcohol (PVA), polymethyl methacrylate (PMMA), polylactic acid (PLA), polyethylene oxide (PEO), polyvinylacetate (PVAc), polyacrylic acid (PAA), polycaprolactone (PCL), polyvinyl fluoride (PVDF), polyvinyl pyrrolidone (PVP), polyacrylonitrile (PAN), polycarbonate (PC), low melting point polyethersulfone, and polyvinyl butyral.

In addition, the aerogel particles 13a contained in the first fiber 13 may be included in the fiber portion 13b so that some of them are exposed to the fiber surface, as shown in FIGS. 5A to 5C.

Meanwhile, the first fiber 13 having a side-by-side cross-sectional structure by the thermal adhesion portion 13c and the fiber portion 13b may be obtained through electrospinning, and may be formed by transporting and ejecting different spinning solutions in which the thermally adhesive resin and the fiber-forming resin are respectively dissolved to the end of the discharge port of the spinning nozzle through different paths structurally separated so as not to be mixed, wherein the spinning nozzle may have, for example, a Y-shaped cross-section.

Meanwhile, according to another embodiment of the present invention, the first fiber web 12 including the above-described thermally adhesive resin may be used as an adhesive member for attaching the first fiber web 10 and the second fiber web 20 with a third fiber web.

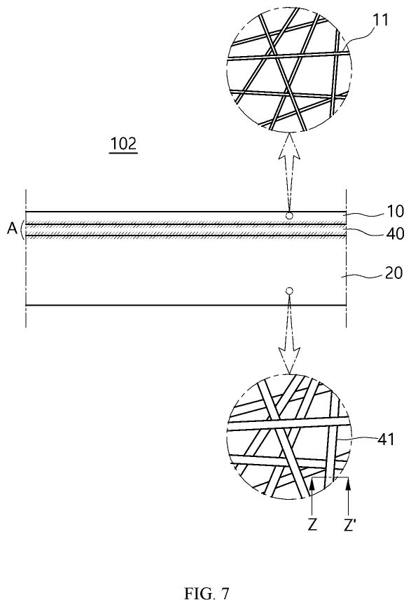

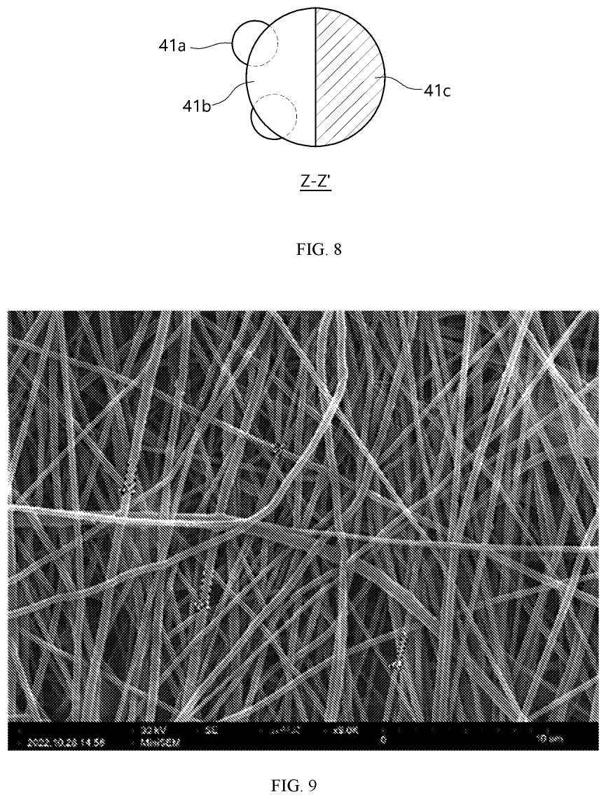

Referring to FIGS. 7 and 8, the third fiber web 40 included in the sound-absorbing and heat-insulating composite fabric 102 may be composed of a third fiber 41 which is a thermally adhesive composite fiber having a side-by-side cross section in which a thermal adhesion portion 41c formed of a thermally adhesive resin and a fiber portion 41b formed of a polymer resin having a melting point higher than that of the thermally adhesive resin are adjacently disposed in a cross-section perpendicular to the longitudinal direction of the fiber.

Here, the third fiber 41 may have a diameter of 1.5 μm or less but may have a diameter equal to or greater than that of the first fiber 11 in order to achieve more improved bonding strength between the first fiber web 10 and the second fiber web 20 and to prevent pore changes even when the thermal adhesion portion 41c is melted. When the diameter of the third fiber 41 exceeds 1.5 μm, it may be difficult to achieve the above-described effect. Meanwhile, the diameter of the fiber having the side-by-side cross-section is defined as a length of the diameter of the longest line among the lines crossing the fiber cross-section.

In addition, the fiber portion 41b in the third fiber 41 may further include aerogel particles 41a in order to exhibit more improved heat insulation and sound absorption performance, wherein the aerogel particles 41a may further include aerogel particles in a content of 3% by weight or more based on the weight of the fiber portion 41b in the third fiber 41.

In addition, the area of the thermal adhesion portion 41c within the cross-section of the third fiber 41 may be 50% or less of the cross-section area, more preferably 10 to 30% of the cross-section area, whereby even when the fusion portion A is formed, it may be advantageous to attach the first fiber web 10 and the second fiber web 20 without changing the pore structure of the first fiber web 10 and the second fiber web 20.

The sound-absorbing and heat-insulating composite fabric 100, 101, or 102 according to one embodiment of the present invention described above includes a first fiber web 10 or 12 comprising first fibers 11 or 13 including aerogel particles 11a or 13a and having a diameter of 1 μm or less, a second fiber web comprising second fibers 21 having a diameter larger than that of the first fibers 11 or 13, and a fusion portion (A) that bonds the first fiber web 10 and the second fiber web 20 at the interface.

In addition, the aerogel particles 11a or 13a may be included in a content of 3 to 30% by weight in the first fibers 11 or 13. In addition, the diameter of the aerogel particles 11a or 13a and the diameter of the first fiber 11 or 13 may have a diameter ratio of 1:3.5 to 50, whereby improved sound absorption and heat insulation performance is exhibited, while the mechanical strength degradation of the first fiber 11 or 13 due to the aerogel particles 11a or 13a is advantageously minimized or prevented, and the spinning properties and spinning workability can also be improved.

Here, the fusion portion (A) may be made of a thermally adhesive resin. For example, the thermally adhesive resin may be included as a component constituting the second fiber 21 in the second fiber web 20, or may be provided through different kinds of fibers including the thermally adhesive resin in the second fiber web 20.

Alternatively, the thermally adhesive resin may be included as a component constituting the first fiber 13 in the first fiber web 12. Alternatively, the thermally adhesive resin may be included as a third fiber web, which is a separate hot melt web, and may be disposed and melted/solidified between the first fiber web 10 and the second fiber web 20. Alternatively, the thermally adhesive resin may be configured as a third fiber web, which is a hot melt web, and the third fiber web 40 may be formed by including a third fiber 41, which is a side-by-side type thermally adhesive composite fiber having a diameter of 1.5 μm or less, so that even when forming a fusion portion, the first fiber web 10 and the second fiber web 20 can be bonded with excellent adhesion strength without blocking the pores.

In addition, the sound-absorbing and heat-insulating composite fabric according to the present invention may be implemented as an interior and exterior material for automobiles. The interior and exterior material for automobiles may be used, for example, as interior materials such as flow carpets, trunk mats, and dashboards, or as undercovers for protecting the lower part of the automobile, such as engines or transmissions, but are not limited thereto, and it is to be noted that they may be applied to known automobile interior and exterior materials.

According to one embodiment of the present invention, the sound-absorbing and heat-insulating composite fabric 100, 101, or 102 may be applied to automobile interior and exterior materials so that the first fiber web 10 or 12 of the sound-absorbing and heat-insulating composite fabric 100, 101, or 102 is positioned toward a light source, a heat source, or a sound wave generating source, and when installed in an automobile, it is preferable that the fabric is installed so that the first fiber web side faces the light source, heat source, or sound wave generating source.

### MODES FOR CARRYING OUT THE INVENTION

Hereinafter, the present invention will be described in more detail by way of the following examples, but it should be understood that the examples are not intended to limit the scope of the present invention, but to aid understanding of the present invention.

### Example 1

In order to prepare a first fiber web, PVDF (Kynar 761, Akema) was used as a fiber-forming resin, and SiO₂ particles having a hollow structure, an average diameter of 70 nm, and a specific surface area of 400 m²/g were used as aerogel particles. In addition, the SiO₂ content was set to 10 parts by weight relative to 100 parts by weight of PVDF polymer resin, and a mixed solvent of DMAc/Acetone (90/10 vol. %) was used as a solvent to prepare a spinning solution so that the concentration of PVDF polymer resin was 15% by weight. The prepared spinning solution was transferred to a spinning nozzle pack using a metering pump, and electrospinning was performed in an atmosphere of a discharge amount of 0.05 cc/ghole per minute, an applied voltage of 20 kV, a distance between a spinning nozzle and a collector of 20 cm, a spinning temperature of 30° C., and a relative humidity of 60%. The accumulated aggregate of first fibers containing aerogel particles obtained by electrospinning was passed through a calender roll preheated to 150° C. to obtain a first fiber web having an average diameter of about 300 nm as shown in FIG. 9.

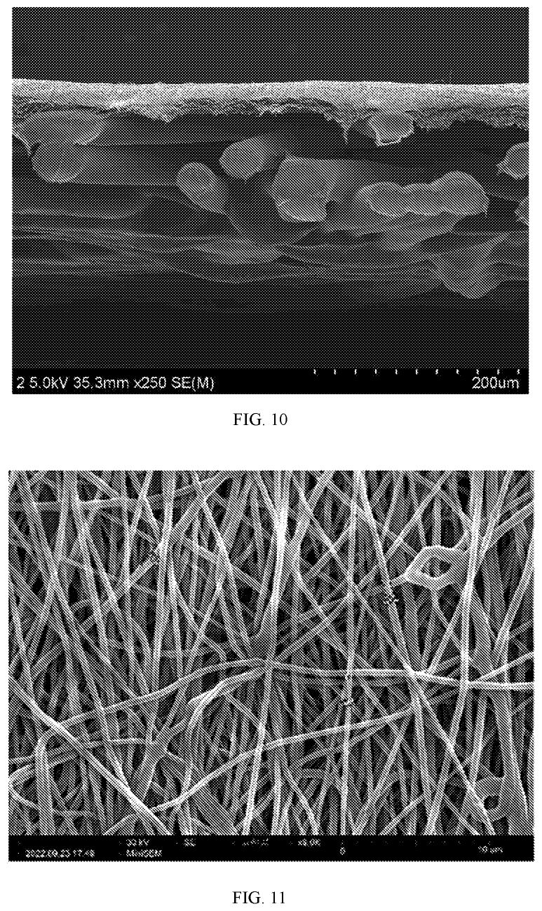

In addition, a second fiber web formed of second fibers, which is PET fibers having a diameter of 10 to 25 μm, and having a thickness of 200 μm was prepared, and then a third fiber web, which is a hot melt web having a thickness of 50 μm, was interposed between the first fiber web and the second fiber web, and then thermal adhesion was performed at a temperature of 150° C. to manufacture a sound-absorbing and heat-insulating composite fabric as shown in FIG. 10.

### Example 2

Except that the content of the aerogel particles contained in the first fiber web was changed to 1 part by weight, the same procedure as in Example 1 was performed to prepare a first fiber web including first fibers having an average diameter of about 300 nm as shown in FIG. 11, and a sound-absorbing and heat-insulating composite fabric was manufactured using the same.

### Experimental Example 1

Scanning electron microscope photographs of the first fiber webs prepared according to Examples 1 and 2 were taken, and the results were shown in FIGS. 9 and 11, respectively. In addition, a scanning electron microscope photograph of the cross-section of the sound-absorbing and heat-insulating composite fabric manufactured according to Example 1 was taken, and the results were shown in FIG. 10.

As can be seen from FIGS. 9 and 11, Example 1 contained 10 times more aerogel particles than Example 2, but no change in the fiber diameter was observed accordingly.

Meanwhile, as can be seen from FIG. 10, the third fiber web can be expected to have melted and penetrated through the pores in the surfaces of the first fiber web and the second fiber web, and in particular, it can be confirmed that the pores of the second fiber web were blocked.

### Example 3

A sound-absorbing and heat-insulating composite fabric was manufactured by performing the same procedure as in Example 1, except that the aerogel particle content was changed to 3 parts by weight, and the first fiber web was prepared to a thickness of 20 μm.

### Comparative Example 1

A sound-absorbing and heat-insulating composite fabric was manufactured by performing the same procedure as in Example 3, except that the first fiber web was prepared without containing the aerogel in the first fiber web.

### Comparative Example 2

A sound-absorbing and heat-insulating composite fabric was manufactured by performing the same procedure as in Example 3, except that the second fiber of the second fiber web was changed to contain the same aerogel particles.

### Comparative Example 3

A sound-absorbing and heat-insulating composite fabric was manufactured by performing the same procedure as in Example 3, except that the prepared first fiber web was treated with a coating composition containing an acrylic binder and the same amount of aerogel particles and dried, instead of containing aerogel particles when preparing the first fiber web.

### Experimental Example 2

### 1. Evaluation of Reflectance

The reflectance in the visible and near-infrared wavelength ranges of the sound-absorbing and heat-insulating fabric manufactured in Example 3 was analyzed using Vis-NIR spectroscopy (Cary 5000 UV-Vis-NIR, US).

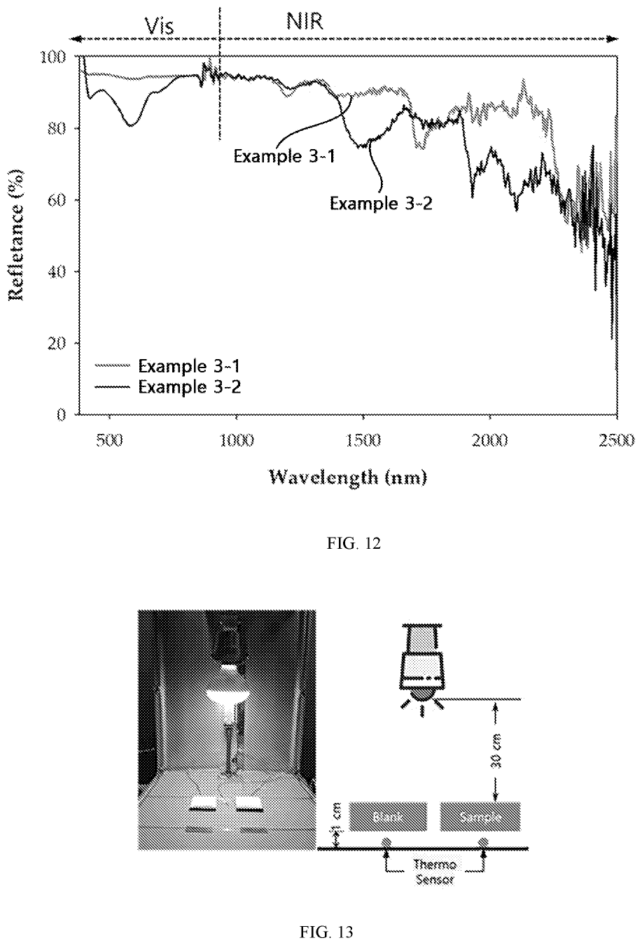

At this time, the light incident surface was divided into the first fiber web (Example 3-1) and the second fiber web (Example 3-2) and analyzed, and the results were shown in FIG. 12, and the reflectance in the visible and near-infrared ranges was shown in Table 1 below.

In addition, the same reflectance analysis was performed on the sound-absorbing and heat-insulating fabrics of Comparative Examples 1 to 3, and the results were shown in Table 1 below.

TABLE 1

| | | Average reflectance (%) | |
|---|---|---|---|
| | Aerogel particles/ | Vis | NIR |
| | Attachment method | (380~780 nm) | (780~2500 nm) |
| Example 3-1 | First fiber | 95.53 | 85.57 |
| (Incident on the first fiber web side) | web/Spinning | | |
| Example 3-2 | | 89.37 | 78.43 |
| (Incident on the second fiber web | | | |
| side) | | | |
| Comparative Example 1 | Not included | 85.34 | 76.85 |
| (Incident on the first fiber web side) | | | |
| Comparative Example 2(Incident on | Second fiber web/ | 90.16 | 79.58 |
| the second fiber web side) | Spinning | | |
| Comparative Example 3(Incident on | First fiber web/ | 92.42 | 80.41 |
| the first fiber web side) | Coating | | |

As can be seen from FIG. 12 and Table 1, it can be seen that in Examples 3-1 and 3-2, the reflectance in the visible light and near-infrared ranges when the first fiber web is positioned as the light incident surface is higher than when the second fiber web is positioned as the light incident surface. This result is considered to result from enhanced phenomenon due to scattering and reflection of light in the first fiber web containing aerogel particles.

In addition, in the case of Comparative Example 1, which did not contain aerogel particles in the first fiber web, the reflectance was significantly reduced compared to Example 3-1, and thus, it is expected that the insulation effect due to light will not be good.

In addition, even when aerogel particles were contained, the improvement in reflectance compared to Example 3-2 was minimal compared to Example 3-1 and Comparative Example 1 when provided on the second fiber web side, which indicates that the fiber diameter of the fiber web containing aerogel particles and the resulting surface morphology affect the reflectance, and that the combination of the first fiber web and the aerogel particles has a synergistic effect.

On the other hand, even when aerogel particles were provided on the first fiber web side, the reflectance of Comparative Example 3 provided through coating was not good compared to Example 3-1, which is expected to be the result of the pores on the surface of the first fiber web being blocked and flattened through the coating.

### 2. Evaluation of Insulation Performance

In order to evaluate the insulation performance, an IR lamp was installed in a chamber equipped with a temperature sensor at the bottom of the sample as shown in FIG. 13, and the heat blocking capability was evaluated. Using an IR lamp made by Iwasaki (500 W, Japan), the measurement was performed at 20° C. for 2,000 seconds, and then the power was turned off to evaluate the infrared blocking rate.

At this time, the sample was the sound-absorbing and heat-insulating composite fabric according to Example 3, and the experiment was conducted by dividing it into a case where the first fiber web was mounted toward the IR lamp (Example 3-1) and a case where the second fiber web was mounted toward the IR lamp (Example 3-2), and the results were shown in Table 2 below.

TABLE 2

| | | | Comparative |
|---|---|---|---|
| | Example | Example | Example 4 |
| | 3-1 | 3-2 | (Blank) |
| Temperature at 2000 seconds after | 48.5 | 49.3 | 52.6 |
| the IR lamp was turned | | | |
| on (T1, ° C.) | | | |
| Temperature at 2000 seconds after | 31.9 | 31.2 | 30.9 |
| the IR lamp was turned | | | |
| off (T2, ° C.) | | | |
| Temperature difference | 16.6 | 18.1 | 21.7 |
| (T1 − T2, ° C.) | | | |

As can be seen from Table 2, it can be seen that:

Example 3-1, in which the heat source was placed on the first fiber web side, suppressed an increase in temperature on the opposite side of the heat source compared to Example 3-2 and Comparative Example 4, and

even after the heat source was removed, the change in temperature on the opposite side of the heat source was measured to be lower in Example 3-1, in which the heat source was placed on the first fiber web side, compared to Example 3-2 and Comparative Example 4, and therefore, even when the same sound-absorbing and heat-insulating composite fabric is used, excellent insulation performance can be achieved when the first fiber web is placed on the heat source side.

### 3. Evaluation of Sound Absorption Performance

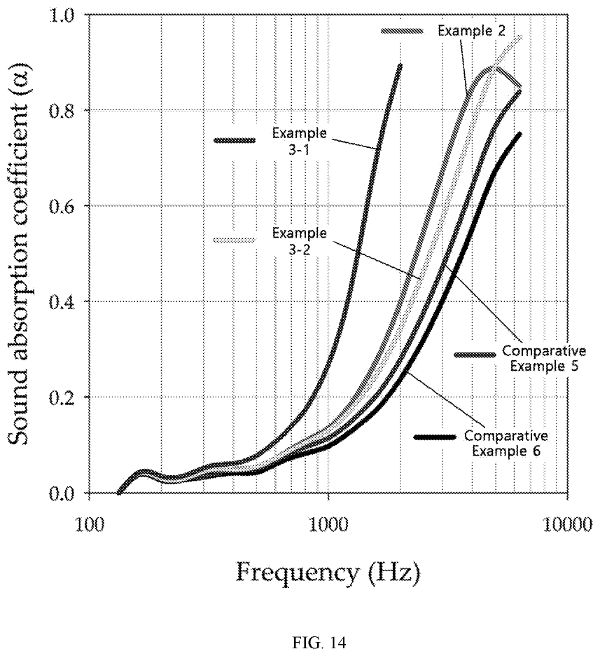

Sound absorption performance was evaluated for the sound-absorbing and heat-insulating composite fabrics according to Examples 2 and 3, and the fabric of the first fiber web alone (hereinafter, referred to as Comparative Example 5) and the fabric of the second fiber web alone (hereinafter, referred to as Comparative Example 6) in Example 3. Here, in the case of Example 3, a case where the first fiber web is disposed toward the noise source is referred to as Example 3-1, and a case where the second fiber web is disposed toward the noise source is referred to as Example 3-2, and the sound absorption performance was evaluated. Specifically, the sound absorption performance was evaluated as a sound absorption coefficient (a), and the sound absorption rate was measured using the impedance tube method of ASTM E 1050 as the sound absorption performance evaluation method, and the results were shown in FIG. 14 below.

As can be confirmed through FIG. 14, it can be seen that:

Example 3-1 exhibits excellent sound absorption performance compared to Example 3-2 and Comparative Examples 5 to 6.

In addition, it can be seen that the sound absorption performance of Example 2 containing 1 part by weight of aerogel particles was measured lower compared to Example 3-1 containing 3 parts by weight of aerogel particles.

### Example 4

A sound-absorbing and heat-insulating composite fabric was manufactured by performing the same procedure as in Example 3, except that a third fiber web, which is implemented by electrospinning the third fiber web to become a third fiber having a side-by-side cross-section manufactured as follows, was used.

Specifically, a first spinning solution for forming a fiber portion and a second spinning solution for forming a thermal adhesion portion were prepared. The first spinning solution was the same as the spinning solution of Example 3. In addition, the second spinning solution was prepared by dissolving polyvinyl butyral (PVB), which has a melting point about 100° C. lower than PVDF as a thermally adhesive resin, in a mixed solvent of DMAc (dimethylacetamide)/acetone (mixing ratio of 80:20 in % by weight) to be 15 wt % of the total weight of the spinning solution.

The prepared first and second spinning solutions were transferred to a spinning nozzle pack, and electrospinning was performed in a spinning atmosphere of a discharge amount of 0.05 cc/ghole per minute, an applied voltage of 20 kV, a distance between a spinning nozzle tip and a collector of 20 cm, a temperature of 30° C., and a relative humidity of 60%, respectively, using a metering pump through different first and second paths in the spinning nozzle, thereby manufacturing a third fiber web formed of third fibers having an average diameter of approximately 500 nm and a side-by-side cross-section with a support portion and a thermal adhesion portion area of 50:50.

Then, the third fiber web was interposed between the first fiber web and the second fiber web, and the first and second fiber webs were laminated through a roller heated to 120° C., which is a range between the glass transition temperature and the melting temperature of PVB, to manufacture a sound-absorbing and heat-insulating composite fabric.

### Example 5

A sound-absorbing and heat-insulating composite fabric was manufactured by performing the same procedure as in Example 4, except that a first fiber web was used, which was implemented with the first fibers having a side-by-side cross-section with a thermal adhesion portion area of about 67% by adjusting the supply speeds of the first and second spinning solutions at a ratio of 1:2 during the manufacture of the first fiber web.

### Examples 6 to 10

Sound-absorbing and heat-insulating composite fabrics were manufactured by performing the same procedure as in Example 4, except that a third fiber web was used, which was implemented with the third fibers having a side-by-side cross-section with a thermal adhesion portion area or a third fiber diameter as shown in Table 3 below by adjusting the supply speeds of the first and second spinning solutions.

### Experimental Example 3

The following properties were evaluated for the sound-absorbing and heat-insulating composite fabrics according to Examples 4 to 10, and were shown in Table 3 below.

### 1. Mechanical Strength

The mechanical strength was measured by a tensile test meter according to ASTM D882-95a for the first fiber web obtained by applying heat and pressure under the same temperature conditions as the lamination conditions to the first fiber web used in the manufacture of the composite fabric according to Examples 4 to 8, and the samples were evaluated at a width of 0.5 cm, a gauge length of 6.0 cm, and a cross-head speed of 10 mm/min. In addition, for the evaluation results, the measurement value of Example 4 was set to 100, and based on this, the measurement values of the remaining examples were expressed as a relative percentage.

### 2. Air Permeability Change Rate

In order to check the pore change rate of the composite fabric due to heat fusion, an air permeability (initial air permeability) was measured with an air permeability measuring device (MODEL FX-3300, TEXTEST), and then heat and pressure at 120° C. were applied twice to the sample for each example, and the air permeability (final air permeability) was measured again under the same pressure conditions. The air permeability change rate was calculated according to the equation below. It can be evaluated that the larger the air permeability change rate, the greater the pore change due to heat fusion.

$$Air permability change rate ( \% ) = [ ( Initial air permeability ( ccs ) - Final air permeability ( ccs ) ) / Initial air permeability ( ccs ) ) ] \times 100 \qquad [ Equation ]$$

TABLE 3

| | Example | Example | Example | Example | Example | Example | Example |
|---|---|---|---|---|---|---|---|
| | 4 | 5 | 6 | 7 | 8 | 9 | 10 |
| Third fiber | Side-by-side composite fiber | | | | | | |
| cross-section shape | | | | | | | |
| Third fiber diameter | 0.5 | 0.5 | 0.5 | 0.5 | 0.5 | 1.5 | 2.0 |
| (μm) | | | | | | | |
| Area of thermal | 50 | 67 | 5 | 11 | 30 | 50 | 50 |
| adhesion portion in | | | | | | | |
| third fiber (%) | | | | | | | |
| First fiber | 100 | 105.0 | 70.9 | 88.4 | 96.7 | Not performed | |
| Mechanical | | | | | | | |
| strength (%) | | | | | | | |
| Air permeability | 16.3 | 49.7 | 0.5 | 1.1 | 4.0 | 18.1 | 26.8 |
| change rate (%) of | | | | | | | |
| composite fabric | | | | | | | |

As can be seen in Table 3, even in the case of the third fiber web formed of the third fiber, which is a thermally adhesive composite fiber with a side-by-side cross-section structure, it can be confirmed that there is a difference in the mechanical strength and the air permeability change rate in the laminated composite fabric depending on the area of the thermal adhesion portion within the third fiber, and it can be expected that the composite fabrics according to Examples 4, 7, and 8 can simultaneously achieve excellent mechanical strength and low pore change rate compared to Examples 5 and 6, and can fully exhibit the initially designed sound-absorbing and heat-insulating properties due to the low pore change rate.

In addition, even in the case of the fiber web formed of the thermally adhesive composite fiber with a side-by-side cross-section structure, the air permeability change due to heat fusion is small in the case of Examples 1 and 9 in which the diameter of the third fiber is 1.5 μm, but the air permeability change is large in the case of Example 10 in which the diameter of the third fiber exceeds 1.5 μm, and thus, the sound-absorbing and heat-insulating properties can be expected to deteriorate.

Although an embodiment of the present invention have been described above, the spirit of the present invention is not limited to the embodiment presented in the subject specification; and those skilled in the art who understands the spirit of the present invention will be able to easily suggest other embodiments through addition, changes, elimination, and the like of elements without departing from the scope of the same spirit, and such other embodiments will also fall within the scope of the present invention.

What is claimed is:

1. A method for manufacturing a sound-absorbing and heat-insulating composite fabric, comprising steps of:
(1) preparing a first fiber web comprising first fibers, and a second fiber web comprising second fibers, wherein the first fibers comprise aerogel particles and have a diameter of 1 μm or less, and the second fibers have a diameter larger than the diameter of the first fibers; and
(2) laminating the first fiber web and the second fiber web by applying heat and pressure.

2. The method according to claim 1, wherein the aerogel particles are comprised in a content of 3 to 50% by weight in the first fibers.

3. The method according to claim 1, wherein a diameter of each of the aerogel particles and the diameter of each of the first fibers have a diameter ratio of 1:3.5 to 50.

4. The method according to claim 1, wherein each of the second fibers in the second fiber web has an average diameter of 5 μm to 30 μm, and a thickness of the second fiber web is 0.2 mm to 40 mm.

5. The method according to claim 1, wherein step (2) is performed after disposing a third fiber web comprising a thermally adhesive resin between the first fiber web and the second fiber web.

6. The method according to claim 1, wherein each of the first fibers has a side-by-side cross-section in which a fiber portion and a thermal adhesion portion having a lower melting point than the fiber portion are adjacently disposed in a cross-section perpendicular to a longitudinal direction of the fiber portion, and the aerogel particles are comprised in the fiber portion.

7. The method according to claim 5, wherein the third fiber web comprises a third fiber having a diameter of 1.5 μm or less but having a diameter equal to or greater than the diameter of the first fibers, and
the third fiber is a thermally adhesive composite fiber having a side-by-side cross-section in which a fiber portion and a thermal adhesion portion having a lower melting point than the fiber portion are adjacently disposed in a cross-section perpendicular to a longitudinal direction of the fiber portion.

8. The method according to claim 7, wherein the fiber portion further comprises aerogel particles in a content of 3% by weight or more based on a weight of the fiber portion.

9. The method according to claim 6, wherein an area of the thermal adhesion portion in the side-by-side cross-section occupies 50% or less of a cross-sectional area.

10. The method according to claim 9, wherein the area of the thermal adhesion portion occupies 10 to 30% of the cross-sectional area.

11. A sound-absorbing and heat-insulating composite fabric, comprising:
a first fiber web comprising first fibers, wherein the first fibers comprise aerogel particles and have a diameter of 1 μm or less;
a second fiber web comprising second fibers, wherein the second fibers have a diameter larger than the diameter of the first fibers; and
a fusion portion positioned at an interface between the first fiber web and the second fiber web to bond the first fiber web and the second fiber web.

12. The sound-absorbing and heat-insulating composite fabric according to claim 11, wherein the aerogel particles are comprised in a content of 3 to 30% by weight in the first fibers.

13. The sound-absorbing and heat-insulating composite fabric according to claim 11, wherein a diameter of each of the aerogel particles and the diameter of each of the first fibers have a diameter ratio of 1:10 to 1:50.

14. The sound-absorbing and heat-insulating composite fabric according to claim 11, wherein a third fiber web comprising third fibers is disposed between the first fiber web and the second fiber web, wherein the third fibers are side-by-side type thermally adhesive composite fibers in which a fiber portion and a thermal adhesion portion having a melting point lower than the fiber portion are disposed adjacently within a cross section and which have a diameter of 1.5 μm or less, and
the fusion portion is formed by fusion between each of the first fibers and the second fibers located at the interface and the thermal adhesion portion in the third fibers.

15. The sound-absorbing and heat-insulating composite fabric according to claim 14, wherein the fiber portion further comprises aerogel particles in a content of 3 to 30% by weight based on a weight of the fiber portion.

16. The sound-absorbing and heat-insulating composite fabric according to claim 11, wherein each of the first fibers has a side-by-side cross-section in which a fiber portion and a thermal adhesion portion having a lower melting point than the fiber portion are adjacently disposed, and the aerogel particles are comprised in the fiber portion; and
the fusion portion is formed by fusion between the thermal adhesion portion and each of the second fibers.

17. An interior and exterior material for an automobile, comprising the sound-absorbing and heat-insulating composite fabric according to claim 11.

18. The interior and exterior material for the automobile according to claim 17, wherein the first fiber web of the sound-absorbing and heat-insulating composite fabric is positioned toward a light source, a heat source, or a sound wave generating source.

19. The method according to claim 7, wherein an area of the thermal adhesion portion in the side-by-side cross-section occupies 50% or less of a cross-sectional area.

20. The method according to claim 19, wherein the area of the thermal adhesion portion occupies 10 to 30% of the cross-sectional area.
